(19) United States
(12) Patent Application Publication
(10) Pub. No.: US 2024/0375466 A1
(43) Pub. Date: Nov. 14, 2024

(54) AUTO CABLE ASSEMBLY HAVING TRAILER CONNECTOR AND 2-PIN CONNECTOR

(71) Applicant: VIAIR CORPORATION, Irvine, CA (US)

(72) Inventor: Sammy CHU, Irvine, CA (US)

(21) Appl. No.: 18/593,700

(22) Filed: Mar. 1, 2024

Related U.S. Application Data
(60) Provisional application No. 63/465,194, filed on May 9, 2023.

(51) Int. Cl. B60D 1/64

(52) U.S. Cl. CPC B60D 1/64

(57) ABSTRACT

An auto cable assembly includes: a cable; a trailer connector plug provided at a first end part of the cable wherein the trailer connector plug is adapted to connect to a trailer connector socket of a vehicle; and a 2-pin connector provided at a second end part of the cable, wherein the 2-pin connector is adapted to connect to a power inlet port of a vehicle accessory such as a portable air compressor for inflating a tire, wherein the trailer connector plug and the 2-pin connector are wired in a manner that the vehicle outputs power to the vehicle accessory via the cable as if the trailer connector plug is properly fitted to the trailer connector socket.

### CROSS-REFERENCE TO RELATED APPLICATIONS

This application claims the benefit of U.S. Provisional Application No. 63/465,194, filed May 18, 2023, the disclosure of which is herein incorporated by reference in its entirety.

### BACKGROUND OF THE INVENTION

### Field of the Invention

The present invention relates to an auto cable assembly having a trailer connector and a 2-pin connector for electrically connecting a vehicle (e.g., a truck or SUV) and an apparatus such as a compressor instead of a trailer.

### Description of the Related Art

Vehicles can operate multiple accessories such as a 12-V compressor for pumping tires of vehicles. Conventionally, when pumping a tire of a vehicle using a 12-V compressor, the 12-V compressor can obtain power in multiple ways, e.g., by using alligator clips, a 2-pin SAE (Society of Automotive Engineers) connector, or the like, which connects the 12-V compressor to a vehicle battery, or by using a cigarette lighter plug, etc. However, these conventional options are inconvenient, difficult, or unstable to operate, or do not output sufficient power for stably operating a 12-V compressor. The above discussion of problems in relation to the related art has been included in this disclosure solely for the purposes of providing context for the present invention, and should not be taken as an admission that any or all of the discussion was known at the time the invention was made.

Any discussion of problems and solutions in relation to the related art has been included in this disclosure solely for the purposes of providing a context for the present invention, and should not be taken as an admission that any or all of the discussion was known at the time the invention was made.

### SUMMARY OF THE INVENTION

An object of the present invention is to provide an auto cable assembly which allows providing power from a vehicle to a vehicle accessory, e.g., a compressor for pumping a tire, in a manner that the accessory can easily be operated, without any inconvenience or difficulty such as connecting the accessory to a battery of the vehicle using allegator clips, and without modification of the vehicle itself, while stably operating the accessory by obtaining higher power than does an accessory plug, e.g., a cigarette lighter plug, inside the vehicle.

To achieve the aforementioned object, by using a trailer connector socket of a vehicle, power is outputted from the vehicle to a vehicle accessory instead of to a trailer. For realizing the above, there is provided an auto cable assembly comprising: (i) a cable; (ii) a trailer connector plug provided at a first end part of the cable wherein the trailer connector plug is adapted to connect to a trailer connector socket of a vehicle; and (iii) a 2-pin connector provided at a second end part of the cable, wherein the 2-pin connector is adapted to connect to a power inlet port of an apparatus, wherein: (a) a terminal a of the trailer connector plug is adapted to connect to a terminal a′ of the trailer connector socket, which connects to a positive terminal of a battery of the vehicle, (b) a terminal b of the trailer connector plug is adapted to connect to a terminal b′ of the trailer connector socket, which connects to a ground in contact with a chassis of the vehicle, (c) the terminal b of the trailer connector plug connects to one of terminals of the trailer connector plug which is adapted to connect to one of terminals of the trailer connector socket for outputting signals for turn, brake, and running lights, wherein a resistor is provided between the terminal b and the one of the terminals, and (d) a first terminal of the 2-pin connector connects to the terminal a of the trailer connector plug by a first wire of the cable, and a second terminal of the 2-pin connector connects to the terminal b of the trailer connector plug by a second wire of the cable.

In an embodiment, the trailer connector plug is a 7-way trailer connector plug which has 7 terminals and which is adapted to connect to a 7-way trailer connector socket of the vehicle.

In another embodiment, the 2-pin connector is a 2-pin SAE connector.

In still another embodiment, the one of terminals of the trailer connector plug is a terminal c adapted to connect to a terminal c′ of the trailer connector socket for outputting signals for right turn/stop.

In yet another embodiment, the resistor has a resistance of approximately 100 Ohm.

In another embodiment, the positive terminal of the battery of the vehicle provides a voltage of 12V.

Further, in another embodiment, the 2-pin connector is adapted to connect to a power inlet port of a portable air compressor for inflating vehicle tires.

In this disclosure, any defined meanings do not necessarily exclude ordinary and customary meanings in some embodiments. Also, in this disclosure, “the invention” or “the present invention” refers to at least one of the embodiments or aspects explicitly, necessarily, or inherently disclosed herein.

According to the aforementioned constitutions, the present invention allows providing power from a vehicle to an accessory, e.g., a compressor for pumping a tire, having a 2-pin connector (e.g., a 2-pin SAE connector) by simply connecting a first end (i.e., a trailer connector such as a 7-way RV plug connector) of an auto cable assembly to a trailer connector socket of the vehicle while connecting a second end (i.e., a 2-pin connector) of the auto cable assembly to the 2-pin connector (i.e., a power inlet port) of the accessory. The connections can be accomplished by easy operation/installation so that the accessory can easily be operated, without any inconvenience or difficulty such as connecting the accessory to a battery of the vehicle using allegator clips. Further, the trailer connector socket of the vehicle can output higher power than does an accessory plug inside the vehicle, so that it can stably operate the accessory.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention.

FIG. 1 is an image showing a concept of an assembly connecting a 7-way RV plug and a 2-pin SAE connector with a cable according to an embodiment of the invention.

FIG. 2 is an image showing a 7-way/2-pin SAE connector according to an embodiment of the invention.

FIG. 3 consisting of images (a) to (e) shows how to use a 7-way/2-pin SAE connector whose first and second end parts are connected to an end part of a vehicle and a compressor, respectively, according to an embodiment of the invention.

FIG. 4 is a schematic wiring diagram showing wiring of a 7-way/2-pin SAE connector between its first end part (the 7-way RV plug) and its second end part (the 2-pin SAE connector) according to an embodiment of the invention (the wiring diagram of the 7-way RV plug is shown as viewed from inside of the plug).

FIG. 5 is a diagram showing functions of 7 terminals of a conventional 7-way RV plug (“Trailer End”) configured to be connected to the corresponding terminals of a socket (“Vehicle End”) provided with a vehicle.

FIG. 6 is a schematic wiring diagram showing a first end part (a 13-way RV plug) of a 13-way/2-pin SAE connector as viewed from inside of the plug according to an embodiment of the invention.

FIG. 7 is a schematic wiring diagram showing a conventional 7-way RV plug wired to relevant parts of a trailer.

Explanation of symbols used is as follows:
11: a 2-pin SAE connector of an auto cable assembly
12: a cable
12a: a first wire
12b: a second wire
13: a cap
21: a 7-way trailer connector plug (7-way RV plug)
21a: a front end
21b: a detachable seal cap
22a: a 12-volt power terminal (terminal a)
22b: a ground terminal (terminal b)
22c: a right-turn signal/stop light terminal (terminal c)
22d: a trailer brake terminal
22e: a left-turn signal/stop light terminal.
22f: a parking light terminal (a tail/running light terminal)
22g: an auxiliary circuit terminal (e.g., a reverse light terminal)
23: a resistor
31: a 2-pin SAE connector on a compressor side
32: a cable extending from a compressor
33: a compressor
41: a 7-way trailer connector socket
41a: a 12-volt power terminal (terminal a)
41b: a right-turn terminal (terminal b)
41c: a ground terminal (for 41i) (terminal c)
41d: a rear fog lamp terminal
41e: a right tail light & number plate light terminal
41f: a break lights terminal
41g: a left trail light & number plate light terminal
41h: a reverse light terminal
41i: a left-turn terminal
41j: an ignition switched power terminal (fridge)
41k: a ground terminal (for 41j)
41l: a non-allocated terminal (spare)
41m: a ground terminal (for 41a, 41b, 41c, 41d, 41e, 41f, 41g, and 41h)
42: a rear face
43: a resistor
44a: a first wire
44b: a second wire
45: a 13-way trailer connector socket (13-way RV plug)

### DETAILED DESCRIPTION OF EMBODIMENTS

In the present disclosure where conditions and/or structures are not specified, a skilled artisan in the art can readily provide such conditions and/or structures, in view of the present disclosure, as a matter of routine experimentation. Also, in the present disclosure including the examples described above, and any values of variables indicated may refer to precise values or approximate values and include equivalents, and may refer to average, median, representative, majority, etc. in some embodiments. Further, in this disclosure, “the invention” or “the present invention” may refer to at least one of the embodiments or aspects explicitly, necessarily, or inherently disclosed herein. Further, in this disclosure, any defined meanings do not necessarily exclude ordinary and customary meanings in some embodiments.

As used herein and in the appended claims, the singular forms “a”, “an”, and “the” include plural referents unless the context clearly dictates otherwise. Thus, for example, reference to “a process” includes a plurality of such processes and reference to “the precursor” includes reference to one or more precursors and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups. Further, the terms “constituted by” and “having” refer independently to “typically or broadly comprising”, “comprising”, “consisting essentially of”, or “consisting of” in some embodiments.

In this disclosure, the trailer connector plug is a plug electrically connected to a trailer, which conventionally provides electrical power (DC power such as 12 V, 24 V, and the like) required for operating the trailer via a cable electrically connected to a vehicle. The number of terminals included in the plug is not particularly limited to, but includes, 7, 13, and the like, depending on the vehicle to which the plug is connected, wherein at least one of the terminals is used as a power output terminal. The trailer is not particularly limited to, but includes, a car trailer, boat trailer, horse trailer, travel trailer, campers, other equipment trailers, construction trailer, large trailers, cargo trailers, agriculture trailers, other heavy-duty landscaping trailer, and the like. The vehicle is also not particularly limited to, but includes, utility vehicles, 5th wheel vehicles, commercial vehicles, and the like. The cable can use various wire sizes which are not particularly limited to, but include 12-gauge wires, 16-gauge wires, and the like, wherein minimum 12 gauge is preferable for power-related functions such as ground, break power, battery power leads, and the like. The 2-pin connector is typically, but not limited to, a 2-pin SAE connector. The SAE connector is a physically self-mating hermaphrodite two-conductor DC connector commonly used for solar and automotive applications (also motorcycles).

In some embodiments, the auto cable assembly comprises the cable, the trailer connector plug provided at a first end part of the cable, and a 2-pin connector provided at a second end part of the cable. The trailer connector plug is adapted to connect to a trailer connector socket of a vehicle; and the 2-pin connector is adapted to connect to a power inlet port of an accessory (such as a portable air compressor) or another device (not limited to a vehicle accessory) (in this disclosure, an accessory and another device are collectively referred to as an “accessory”). One of the terminals (terminal a) of the trailer connector plug is adapted to connect to a terminal (terminal a′) of the trailer connector socket of the vehicle, which connects to a positive terminal of a battery of the vehicle, whereas another terminal (terminal b) of the trailer connector plug is adapted to connect to another terminal (terminal b′) of the trailer connector socket, which connects to a ground in contact with a chassis of the vehicle, so that power necessary for operating the accessory or apparatus can effectively be outputted from the vehicle to the accessory via the auto cable assembly.

In some embodiments, the terminal b of the trailer connector plug connects to one of terminals of the trailer connector plug, which is adapted to connect to one of terminals of the trailer connector socket for outputting signals for turn, brake, and running lights, wherein a resistor is provided between the terminal b and the one of the terminals, so that the vehicle outputs power through the trailer connector plug as if the trailer connector plug is properly electronically fitted to a trailer. In some vehicles, electrical connection between the trailer connector socket and the trailer connector plug can be established only when the trailer connector plug is properly fitted in the trailer connector socket in order to provide power and signals constantly and securely to a trailer. Thus, when some of the terminals of the trailer connector socket cannot establish connection to the corresponding terminals of the trailer connector plug, no power or signals can be outputted from the vehicle to the trailer. However, according to the above embodiments, despite the fact that only two terminals (the terminals a and b) of the trailer connector plug are used for obtaining power, by connecting the terminal b of the trailer connector plug to one of terminals of the trailer connector plug which is adapted to connect to one of terminals of the trailer connector socket for outputting signals for turn, brake, and running lights, wherein a resistor is provided between the terminal b and the one of the terminals, the one of the terminals creates a false signal which allows the vehicle to output power through the trailer connector plug as if connection between the trailer connector socket and the trailer connector plug is properly established. The one of the terminals of the trailer connector plug can be any terminal (or it can be constituted by two or more terminals), other than the terminal a or b, as long as it can send a false signal to falsely establish the connection therebetween. In some embodiments, the one of the terminals of the trailer connector plug is a terminal c adapted to connect to a terminal c′ of the trailer connector socket for outputting signals for right turn/stop.

In some embodiments, the resistor used to bridge the terminal b and the one of the terminals may have a resistance of approximately 100 ohm or any workable resistance, depending on the profiles of the trailer connector socket of the vehicle.

In some embodiments, a first terminal of the 2-pin connector connects to the terminal a of the trailer connector plug by a first wire of the cable, and a second terminal of the 2-pin connector connects to the terminal b of the trailer connector plug by a second wire of the cable.

The embodiments will be explained with respect to preferred embodiments. However, the present invention is not limited to the preferred embodiments.

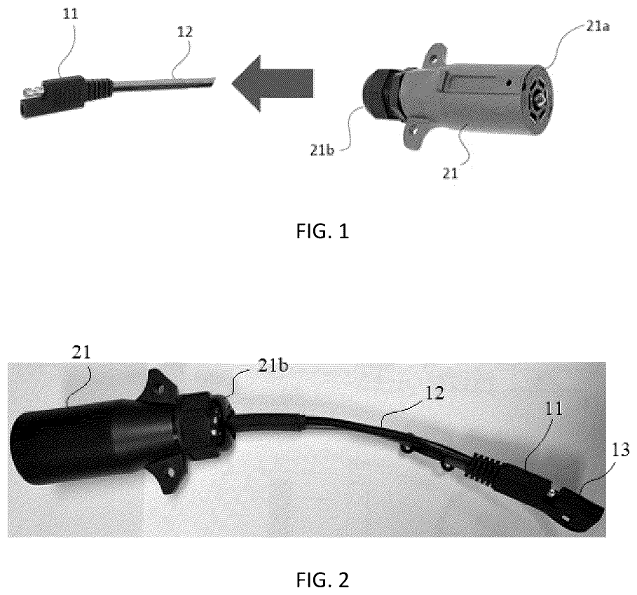

FIG. 1 is an image showing a concept of an assembly connecting a 7-way trailer connector plug 21 and a 2-pin SAE connector 11 with a cable 12 according to an embodiment of the invention. FIG. 2 is an image showing a 7-way/2-pin SAE connector (an auto cable assembly) according to an embodiment of the invention. In this disclosure, the 7-way trailer connector may also be referred to as the “7-way RV plug” or “7-way plug,” the 2-pin SAE connector may also be referred to as the “2-pin connector,” and the 7-way/2-pin SAE connector may also be referred to as the “7-way/2-pin connector.” In the embodiments, the 7-way plug is provided at a first end part of the cable 12, whereas the 2-pin connector is provided at a second end part of the cable 12. The 7-way plug has a front end 21a with 7 terminals (6 receptacles with a center projection) which are fitted to the corresponding 7 terminals (6 pins with a center recess) of a 7-way trailer connector socket (also referred to as the “7-way socket), respectively. The 7-way plug 21 can be attached to the cable in a waterproof sealed manner using a detachable seal cap 21b. The 2-pin connector 11 has a detachable cap 13 to protect the end of the 2-pin connector. The cable 12 is constituted by two wires connecting their first ends to the terminals a and a′, respectively, and their second ends to the terminal b and b′, respectively. The wire size may be at least 16 or 12 gauge in some embodiments.

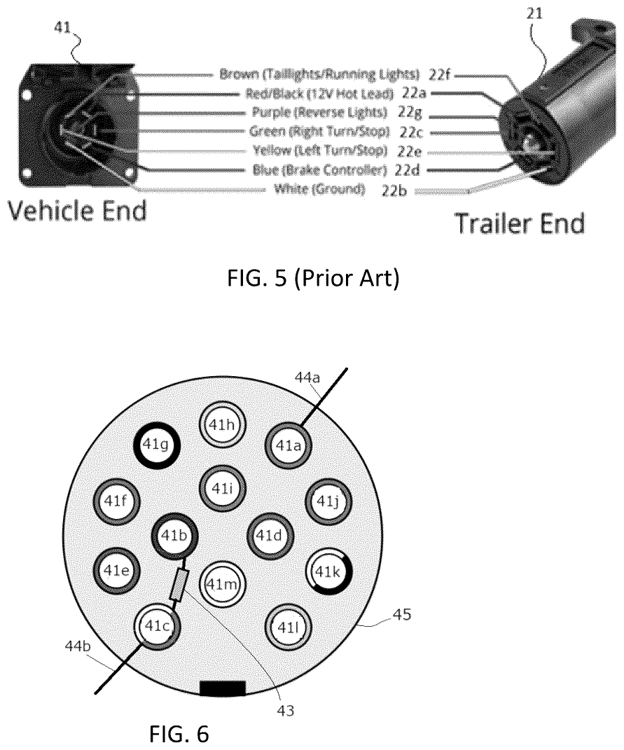

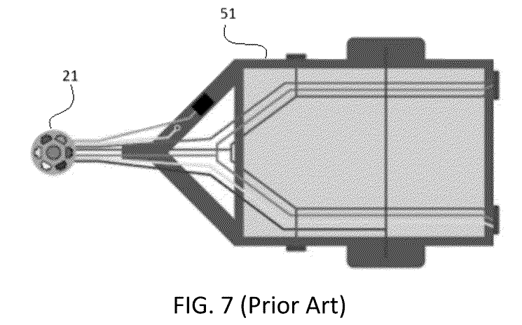

A 7-way RV plug 21 is conventionally used for electrically connecting a vehicle (e.g., a truck or SUV) and a trailer, and it brings the necessary power and related functions to the trailer that is towed. Most new vehicles equipped with a tow package have connectors which allow trailers to use electric brakes, etc. FIG. 7 is a schematic wiring diagram showing a conventional 7-way RV plug wired to relevant parts of a trailer, wherein a 7-way RV plug 21 is provided with a trailer 51 in the vicinity of a trailer connector for towing the trailer 51 by a vehicle so that the 7-way RV plug is readily electrically connected to the vehicle for controlling the trailer. The 7-way RV plug is a male plug which is mechanically fitted in and electronically connected to a socket of the vehicle. The 7-way RV plug uses 7 wires which extend from corresponding 7 terminals (6 receptacles with a center projection) of the 7-way RV plug. FIG. 5 is a diagram showing functions of 7 terminals of a conventional 7-way RV plug (“Trailer End”) configured to be connected to the corresponding terminals of a 7-way socket (“Vehicle End”) provided with a vehicle (the diagram is taken from a webpage at https://www.etrailer.com/faq-wiring-7-way.aspx., Aug. 23, 2023, which is incorporated by reference in its entirety), wherein the SAE standard color code for 7-way wiring harnesses is indicated. As shown in FIG. 5, the 7-way wiring harness has the following seven ports (colors in parentheses are those according to the SAE standard color code): port 22f: taillight/running lights (brown); port 22a: 12 V hot lead (red/black); port 22g: reverse lights (purple); port 22c: right turn/stop (green); port 22c: left turn/stop (blue); and port 22b: ground (white). Although the color coding and allocated functions of the terminals are slightly different depending on the vehicle, any conventional 7-way plugs and any new 7-way plugs can be used in some embodiments, as long as it includes a terminal a adapted to connect to a terminal a′ of the trailer connector socket connected to a positive terminal of a battery of the vehicle, a terminal b adapted to connect to a terminal b′ of the trailer connector socket connected to a ground in contact with a chassis of the vehicle, and a terminal c adapted to connect to a terminal c′ of the trailer connector socket for outputting signals for, e.g., right turn/stop.

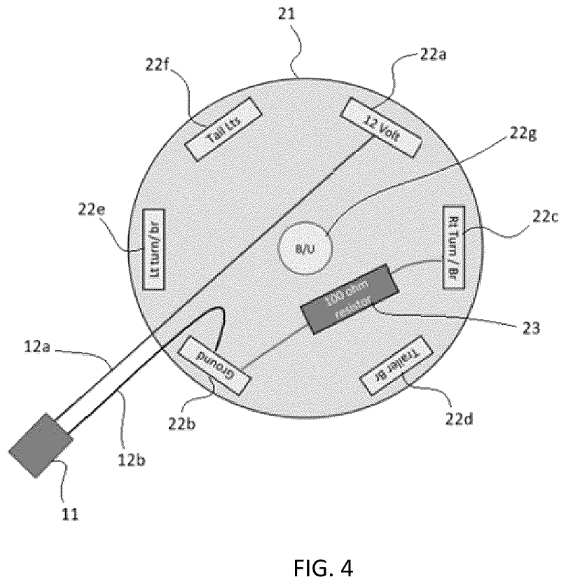

FIG. 4 is a schematic wiring diagram showing wiring of a 7-way/2-pin SAE connector between its first end part (the 7-way RV plug 21 shown in FIG. 5) and its second end part (a 2-pin SAE connector 11) according to an embodiment of the invention (the wiring diagram of the 7-way RV plug 21 is shown as viewed from inside of the plug 21). The 2-pin SAE connector is known in the art (e.g., a webpage at https://en.wikipedia.org/wiki/DC_connector, Aug. 23, 2023, which is incorporated by reference in its entirety). The 7-way RV plug uses 7 wires which extend from the corresponding 7 blades/pins provided inside the corresponding 7 terminals (6 receptacles with a center projection) at the front end of the plug, wherein the wires can be exposed by removing a cover and a wire sheathing (not shown). The 7 wires are connected to the terminals 22a to 22g as explained in FIG. 5. In this embodiment, all the wires connected to the terminals are removed, and a first wire 12a and a second wire 12b extending from the 2-pin SAE connector 21 are connected to the terminal 22a and the terminal 22b, and a resistor 23 is provided to connect the terminal 22b and the terminal 22c. The wire sheathing and the cover are replaced, and the detachable seal cap 21b is attached to seal the 7-way plug 21.

In some embodiments, as shown in FIG. 4, the terminals (22d, 22c, 22f, and 22g) of the trailer connection plug 21, which are not used, have no wire attached thereto, and only the two wires 12a, 12b are led out from the trailer connection plug 21. However, in some embodiments, one or more of the above unused terminals each can be connected to the ground terminal 22b via a resistor in order to establish electrical connection between the trailer connector plug and the trailer connector socket as if the trailer connector plug is of a trailer and properly fitted to the trailer connector socket. Further, as shown in FIG. 4, in some embodiments, the cable is a single cable which consists of the two wires 12a, 12b, and no connector between the trailer connector plug 21 and the 2-pin connector 11 is provided. However, in some embodiments, the cable can be constituted by two or more cables which are connected to each other in series with a connector.

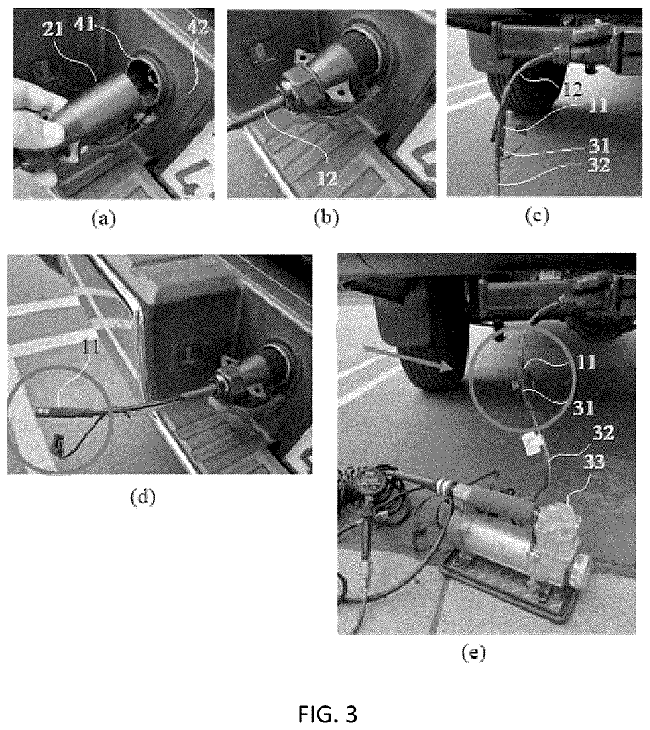

FIG. 3 consisting of images (a) to (c) shows how to use a 7-way/2-pin SAE connector whose first and second end parts are connected to an end part of a vehicle and a compressor, respectively, according to an embodiment of the invention. As shown in image (a), a 7-way trailer connector socket 41 is normally provided on a rear face 42 of a vehicle near a rear bumper. The socket 41 has a cover, and after opening the cover to expose the recess of the socket 41, the plug 21 is fitted in the socket 41 as shown in image (b). The other end of the cable 12 is connected to a 2-pin SAE connector 11 as shown in image (d) (in a circle). The 2-pin SAE connector 11 is fitted to a 2-pin SAE connector 31 on a compressor side which is connected to a portable air compressor 33 for inflating a tire via a cable extending from the compressor 33 as shown in images (c) and (c) (in a circle). Note that the vehicle in images (c) and (e) is different from the vehicle in images (a), (b), and (d) to illustrate a completed state of the connection. By using the auto cable assembly, the connection is established by easy and secure operation/installation, so that the compressor can easily be operated using the vehicle's battery, without any inconvenience or difficulty such as connecting the compressor to the vehicle's battery using allegator clips.

The trailer connector plug can be modified so as to apply to other trailer connector sockets such as that shown in FIG. 6. FIG. 6 is a schematic wiring diagram showing a first end part (a 13-way RV plug 45) of a 13-way/2-pin SAE connector as viewed from inside of the plug according to an embodiment of the invention. In this embodiment, there are 13 terminals provided in the plug: a 12-volt power terminal (terminal a) 41a, a right-turn terminal (terminal b) 41b, a ground terminal (for 41i) (terminal c) 41c, a rear fog lamp terminal 41d, a right tail light & number plate light terminal 41e, a brake light terminal 41f, a left trail light & number plate light terminal 41g, a reverse light terminal 41h, a left-turn terminal 41i, an ignition switched power terminal (fridge) 41j, a ground terminal (for 41j) 41k, a non-allocated terminal (spare) (41l), and a ground terminal (for 41a, 41b, 41c, 41d, 41c, 41f, 41g, and 41h) 41m (e.g., a webpage at https://www.malcolms.ic/towbars/information/towbar-electrics-wiring-diagrams, Dec. 30, 2023, which is incorporated by reference in its entirety). Among these terminals, a first wire 44a is connected to the terminal 41a, a second wire 44b is connected to the terminal 41c, and the terminal 41b and the terminal 41c are connected by a resistor 43, so that the terminal 41b creates a false signal which allows the vehicle to output power through the trailer connector plug 45 as if connection between the trailer connector socket and the trailer connector plug is properly established, as in a manner explained in relation to FIG. 4.

The auto cable assembly disclosed herein allows providing power from a vehicle to an accessory, e.g., a compressor for pumping a tire, having a 2-pin connector by simply connecting a first end of the auto cable assembly to a trailer connector socket of the vehicle while connecting a second end of the auto cable assembly to the 2-pin connector of the accessory. The auto cable assembly allows obtaining sufficient and stable power from a vehicle and outputting power by easy operation/installation, and thus, even when an accessory has a power inlet connector other than a 2-pin SAE connector, it can be operated by connecting the auto cable assembly and an adaptor/connector which can connect the power inlet connector and the 2-pin SAE connector of the auto cable assembly. The auto cable assembly is widely applicable to various types of accessories.

What is claimed:

1. An auto cable assembly comprising:
a cable;
a trailer connector plug provided at a first end part of the cable wherein the trailer connector plug is adapted to connect to a trailer connector socket of a vehicle; and
a 2-pin connector provided at a second end part of the cable, wherein the 2-pin connector is adapted to connect to a power inlet port of an apparatus,
wherein:
terminal a of the trailer connector plug is adapted to connect to terminal a′ of the trailer connector socket, which connects to a positive terminal of a battery of the vehicle,
terminal b of the trailer connector plug is adapted to connect to terminal b′ of the trailer connector socket, which connects to a ground in contact with a chassis of the vehicle,
terminal b of the trailer connector plug connects to one of terminals of the trailer connector plug which is adapted to connect to one of terminals of the trailer connector socket for outputting signals for turn, brake, and running lights, wherein a resistor is provided between terminal b and the one of the terminals, and
a first terminal of the 2-pin connector connects to terminal a of the trailer connector plug by a first wire of the cable, and a second terminal of the 2-pin connector connects to terminal b of the trailer connector plug by a second wire of the cable.

2. The auto cable assembly according to claim 1, wherein the trailer connector plug is a 7-way trailer connector plug which has 7 terminals and which is adapted to connect to a 7-way trailer connector socket of the vehicle.

3. The auto cable assembly according to claim 1, wherein the 2-pin connector is a 2-pin SAE connector.

4. The auto cable assembly according to claim 1, wherein the one of terminals of the trailer connector plug is terminal c adapted to connect to terminal c′ of the trailer connector socket for outputting signals for right turn/stop.

5. The auto cable assembly according to claim 1, wherein the resistor has a resistance of approximately 100 Ohm.

6. The auto cable assembly according to claim 1, wherein the positive terminal of the battery of the vehicle provides a voltage of 12V.

7. The auto cable assembly according to claim 1, wherein the 2-pin connector is adapted to connect to a power inlet port of a portable air compressor for inflating vehicle tires.
